(19) United States
(12) Patent Application Publication
(10) Pub. No.: US 2011/0078917 A1
(43) Pub. Date: Apr. 7, 2011

(54) Coal fine drying method and system

(76) Inventors: Richard W. Bland, Beckley, WV (US); Philip Harsh, Blandon, PA (US); Michael Hurley, Lancaster, PA (US); Andrew K. Jones, Lancaster, PA (US); Vinod K. Sikka, Oak Ridge, TN (US)

(21) Appl. No.: 12/924,570

(22) Filed: Sep. 30, 2010

Related U.S. Application Data
(60) Provisional application No. 61/247,688, filed on Oct. 1, 2009.

(51) Int. Cl. F26B 7/00; F26B 17/00; F26B 9/00

(52) U.S. Cl. 34/354; 34/95

(57) ABSTRACT

The present invention provides a method and system for drying coal fines using molecular sieves. The method and system dries the coal fines by combining coal fines with the molecular sieves. While in combination, the mixture is agitated to maximize surface contact between the molecular sieves and the coal fines. As the coal fines contact the molecular sieves, the surfactant moisture on the coal fines is then absorbed by the molecular sieves. The molecular sieves allow for the water molecules to pass into the sieves, thus being removed from the coal fines. After a period of agitation, the method and system thereby separates the molecular sieves and the coal fines.

### RELATED APPLICATION

The present application relates to and claims priority to Provisional Patent Application Ser. No. 61/247,688 entitled METHOD OF DRYING COAL FINES filed Oct. 1, 2009.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to remove moisture from coal and more specifically to drying coal fines.

### BACKGROUND OF THE INVENTION

In the continued push for cleaner technology trends, a concurrent growth trend is the better utilization of existing resources. A common and abundant energy resource is coal. But, there are various concerns and issues associated with coal that challenge the cost-effectiveness and product maximization in the current industry.

Due to mining and processing operations, processed coal typically has high moisture content. Based on the structure of coal, this moisture content is surface level moisture. The inclusion of too much moisture in coal is problematic from both a cost perspective and a use perspective.

From a cost perspective, customers pay for coal by weight. Inclusion of high moisture content increases the weight of the coal, thus having to be sold at a lower price. Similarly, coal's use for energy purposes is based on the burning of the coal. The inclusion of excess moisture content reduces the effectiveness of the coal because of energy wasted to evaporate off the moisture. When coal is sold, it typically includes a moisture level rating, where a portion of the price is based on this rating. The lower the moisture content, the greater the expected costs for purchasing coal.

Existing techniques for processing coal are extremely inefficient at maximizing the return based on the volume of extracted coal. In a typical environment, the coal is sorted by size using known sorting techniques. Then, the coal is segmented, with a lower quality material being separated from the higher quality material by specific gravity in a wet process, and sold based on the sorted sizes, with a corresponding moisture content rating. For coal, greater surface area means higher moisture content because the total moisture in coal is made up largely of surfactant moisture. Therefore, larger coal pieces, by volume, have a lower moisture percentage compared with the same corresponding volume of smaller coal pieces.

Current techniques for drying coal utilize heat and/or centrifugal force, drying the pieces of coal that have been separated into different sizes. Current centrifugal drying techniques provide for disposal, wasting, of the smallest coal pieces, also referred to as coal fines, because based on centrifugal drying techniques, there lacks a known means to centrifugally dry the smallest of the coal fines as well as a cost-effective incentive to attempt to dry these smallest of the coal fines. The costs associated with centrifugally drying coal fines are greater than the return achieved by selling the coal fines themselves.

Current thermal drying techniques cause the loss and therefore the disposal of a portion of the smallest coal pieces, also referred to as coal fines, because based on current thermal drying techniques, there lacks a known means to retain these dried coal fines. Also, the known thermal drying technique requires that all of the sellable coal, regardless of its size, must be included in the thermal drying process to prevent the creation of a dangerous and hazardous atmosphere in the thermal dryer caused when only fine coal is placed into the thermal dryer. This requires an excess cost to dry this coal.

Coal is sold as a mixture of the various sizes and when sold, the coal is priced based on volume and moisture content. To achieve a low moisture content for pricing purposes, current techniques thus have processing facilities excluding the coal fines from being sold as the high moisture content of the coal fines negatively effects the overall moisture content of a volume of coal (e.g. tonnage). Therefore, in current techniques, processing facilities simply discard large volumes of coal because it is not cost-effective to dry the coal fines.

Concurrently, there are known technologies called molecular sieves. These molecular sieves are a form of nanotechnology used for extracting moisture from airborne, aerosol and liquid environments. Molecular sieves are used in aerosol environments, for example, in natural gas pipelines to extract foreign molecules from the natural gas and, another example is in the chemical processes. Molecular sieves work on a nanotechnology level by having surface openings of a defined size, such as 4 angstroms for example. The openings in the molecular sieves are such that only molecules of a particular size then enter the sieve and larger molecules bypass these sieves and the passing of these molecules is based on the natural molecular flow presented in the gaseous or liquid medium.

Relative to mining coal, no viable solutions have been presented to dry the coal fines to a moisture content that makes them economically saleable or to prevent the loss of the smallest of the fine coal to the waste. The existing techniques of using coal fines beyond a moisture content of around 30% typically employs blowers and heaters, which require capital intensive investment, require substantial energy use, and creates environmental problems and hazards. These hazards are from both energy use and aerolization of the coal fines.

As such, there exists an economical need for a method and system for drying coal fines to reduce the moisture content and to prevent the substantial loss of fine coal in the drying process. The reduction in moisture content thereby reduces coal waste because now the coal fines are no longer discarded nor lost to waste, as well as reduced energy consumption required to dry un-discarded coal fines to an acceptable level. The reduction in moisture also seeks using a new means which will also reduces aerosolization hazards associated with the existing coal fine drying techniques.

### SUMMARY OF THE INVENTION

The present invention provides a method and system for drying coal fines using molecular sieves. The method and system dries the coal fines by combining coal fines with the molecular sieves. While in combination, the mixture is agitated to maximize surface contact between the molecular sieves and the coal fines. As the coal fines contact the molecular sieves, the surfactant moisture on the coal fines is then absorbed by the molecular sieves. The molecular sieves allow for the water molecules to pass into the sieves, thus being removed from the coal fines. After a period of agitation, the method and system thereby separates the molecular sieves and the coal fines.

The method and system may use additional techniques for adjusting the volume of coal fines and/or molecular sieves, as well as or in addition to adjust the agitation time-period to maximize the percentage of moisture removal. The method and system may also dry the molecular sieves to remove the extracted moisture and thus re-use the molecular sieves for future moisture removal operations. The method and system may also add the coal fines having the moisture removed therefrom back into a coal pile having coal pieces of varying sizes for sale.

Thereby, the method and system provides the recapture and utilization of coal fines by allowing for the removal of moisture using molecular sieves. The utilization of molecular sieves significantly reduces processing inefficiencies found in other processing techniques, as well as being environmentally friendly by eliminating the waste of coal fine in the existing drying technology.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for drying coal fines;

FIG. 2 illustrates a flowchart of steps of one embodiment for drying coal fines;

FIG. 3 illustrates another embodiment of a system for drying coal fines; and

FIG. 4 illustrates a flowchart of steps of another embodiment for drying coal fines.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

FIG. 1 illustrates one embodiment of a system 100 for drying coal fines. The system 100 includes a molecular sieve distribution unit 102, a coal fine distribution unit 104, a combination unit 106 and a separator 108. From the separator 108 are dispersed coal fines 110 and molecular sieves 112.

The system 100 operates to remove moisture from coal fines by having the molecular sieves in contacting engagement with the coal fines. The material science of the molecular sieves allow for the absorption and/or absorption of the surfactant moisture on the coal fines. By facilitating surface area contact between the molecular sieves and the coal fines, the moisture is then transferred from the coal fines to the molecular sieves. Based on sizing differences between the molecular sieves and the coal fines, the coal fines may be readily separated from the molecular sieves. Thereby, once the separation occurs, the remaining coal fines have a reduced moisture content level. The described techniques overcome the problems associated with the prior techniques of drying coal fines because it eliminates the need for energy-intensive drying operations and does not generate any airborne particulates common with the heat-based the drying techniques.

The molecular sieve distribution unit 102 includes a plurality of molecular sieves. Various embodiments are envisioned for these sieves. Molecular sieves are materials containing pores of a precise and uniform size (pore sizes are typically from about 3 to about 10 Angstroms) that are used as an adsorbent for gases and liquids. Without wishing to be bound by any theory, generally molecules small enough to pass through the pores are adsorbed while larger molecules cannot enter the pores. Molecular sieves are different from a common filter in that they operate on a molecular level. For instance, a water molecule may not be small enough to pass through while the smaller molecules in the gas pass through. Because of this, they often function as a desiccant. Some molecular sieves can adsorb water up to 22% of their dry weight.

Molecular sieves often consist of aluminosilicate minerals, clays, porous glasses, microporous charcoals, zeolites, active carbons (activated charcoal or activated carbon), or synthetic compounds that have open structures through or into which small molecules, such as nitrogen and water can diffuse.

A variety of molecular sieves can be employed alone or in combination to remove water or moisture from coal fines as described in further detail below. In one embodiment, molecular sieves may be selected from aluminosilicate minerals, clays, porous glasses, microporous charcoals, zeolites, active carbons, or synthetic compounds that have open structures through or into which small molecules, such as nitrogen and water can diffuse. In other embodiments, molecular sieves may be selected from any other suitable material(s) recognized by one skilled in the art such that the molecular sieve is operative to perform the adsorption or absorption properties described herein.

Molecular sieves with pores large enough to draw in water molecules, but small enough to prevent any of the coal fines from entering the sieves, can be advantageously employed. Hardened molecular sieves also provide the benefit of not breaking down as easily and are readily re-usable once the absorbed water is removed, as described below.

In some embodiments molecular sieve particles are greater than 1, 1.25, 1.5, 1.75, 2.0, 2.25 or 2.5 mm in diameter and less than about 5 mm or 10 mm. When mixed with the wet coal fines having excess moisture, the molecular sieves quickly draw the moisture from the coal fines. As the sieves are larger than the coal fines (e.g., over a millimeter in diameter), the mixture of sieves and coal fines can be lightly bounced on a fine mesh grid, where the dry coal fines can be separated from the molecular sieves.

The coal fine distribution unit 104 has coal fines stored therein. The coal fines are generated based on the sorting and separation of extracted coal into various sizes. The coal fines may be generated from known sorting techniques of sorting the coal into smaller and smaller pieces using any number of a variety of techniques, such as multiple screens wherein coal elements of smaller sizes fall through screens for separation. In one embodiment, the coal fines may be between the sizes of 28 mesh to zero, but it is recognized that the coal fines may be further distinguished in size below size zero or may be further defined into sizings below 28 mesh, wherein the 28 mesh to zero is an exemplary sizing descriptor, but not as a limiting dimension for the coal fines utilized herein.

The combination unit 106 may be any number possible devices for combining the molecular sieves and coal fines. The combination unit 106 includes functionality for the contacting engagement of the coal fines with the molecular sieves, plus some degree of agitation. As noted above, the molecular sieves operate by removing surfactant moisture, therefore the agitation of the combined mixture of molecular sieves and coal fines increases the surface area contact therebetween.

The separated molecular sieves can be a bit dusty and can carry a minute amount of coal fines with them after they have absorbed the water. Once separated, the molecular sieves can be passed to a heater where they can be dried and sufficient moisture is removed to permit their reuse if desired. Thus, the molecular sieves can be employed in a close-loop system, where they are mixed with the coal fines, and after removing water/moisture (drying) they are separated from the coal fines and passed through a heater and reused.

For example, in one embodiment the combination unit 106 may be a circular tube having a circular channel through which the combined mixture of coal fines and molecular sieves pass. This circular tube may be rotated at a particular speed and the tube extended for a particular distance so the coal fines and molecular sieves are engaged for a certain period of time. Typically, the longer the engagement, the more moisture that is removed. As described in further embodiments below, additional feedback can be implemented to adjust the combination unit 106 and thus adjust the moisture level of the coal fines. In one embodiment, the combination unit 106 may use a FEECO International paddle mixer Model No. 6016 running at 55 RPM with paddle angles set at 20 degrees and mixing 60 tons per hour of a mixture of wet coal fines and nanosieves. In one embodiment, but not a limiting range, the mixing tonnage may have a combination range between 4 parts nanosieve to 1 part wet coal fines to 1 part nanosieves to 1 part wet coal fines, depending on the desired moisture content of the final product.

Another embodiment of the combination unit 106 may be an agitation device or other platform that includes vibration or rotation to cause surface area contact between the coal fines and the molecular sieves. Additional embodiments of the combination unit 106, as recognized by one skilled in the art, may be utilized providing for the above-described functionality of facilitating contacting engagement between the coal fines and the molecular sieves.

The separator 108 may be any suitable separation device recognized by one skilled in the art. The separator 108 operates using known separator techniques, including for example in one embodiment vibration and vertical displacement. The separator 108 operates by, in one embodiment, providing holes or openings too large that the molecular sieves will not pass through, but the coal fines readily pass therethrough. For example, one embodiment may include a high frequency, low amplitude circular screen for filtering the coal fines from the molecular sieves.

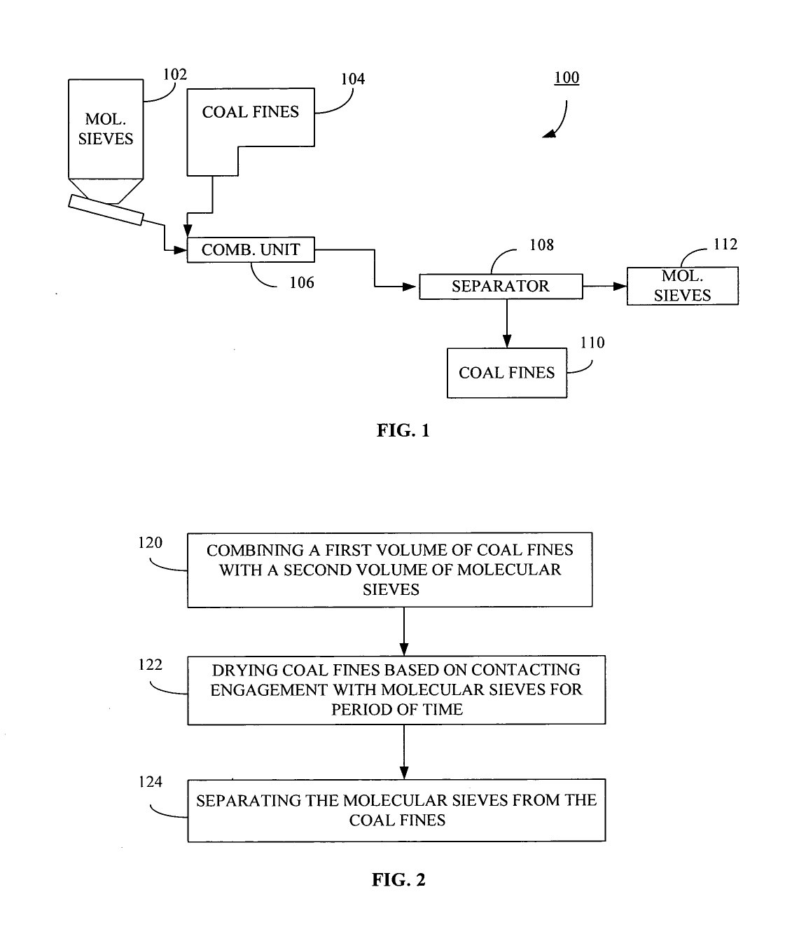

For the sake of brevity, one embodiment of the operations of the system 100 is described relative to the flowchart of FIG. 2. The flowchart of FIG. 2 illustrates the steps of one embodiment of a method for drying coal fines. The method includes the step, step 120, of combining a first volume of coal fines with a second volume of molecular sieves. With respect to the system 100 of FIG. 1, the molecular sieves are dispensed from the molecular sieve distribution unit 102 and the coal fines are dispensed from the coal fine distribution unit 104.

By way of example, and not meant as a limiting measurement, one embodiment may include 4533 molecular sieves per ton of coal fines per hour. These volumes are exemplary for a continuous flow drying operation as described in further detail below. In this example, the first volume and second volume are relative to flow rates for the corresponding elements. The flow rate may be dependent upon a belt speed and size, as well as the corresponding available volume in the combination unit. By way of example, a coal drying operation may seek contact time of 2 minutes and have a belt speed of 40 feet per minute with a contact distance of 80 feet. If the coal fines feed rate is 100 tons per hour, the feed rate may be 83.33 pounds of per feet of wet coal. A mixture ratio of molecular sieves to coal fines may be 0.68 tons per hour molecular sieves to tons per hour wet coal with a pounds per feet rate of 56.67. Under this example, that would require approximately 4533 molecular sieves per ton of coal fines per hour.

The molecular sieve distribution unit 102 releases a predetermined volume of molecular sieves at a predetermined rate. This volume of sieves is in proportion to the volume of coal fines. Both units 102 and 104 dispense the corresponding elements into the combination unit 106. One embodiment may rely on gravity to facilitate distribution, as well as additional conveyor or transport means may be used to direct the elements from the distribution units 102 and 104 to the combination unit 106. For example, one embodiment may include conveyor belts to move the coal fines and/or molecular sieves into the combination unit 106.

Once the combination unit 106 has the volumes of molecular sieves and coal fines, the next step of the method of FIG. 2 includes drying the coal fines based on contacting engagement of the molecular sieves and the coal fines. As described above, the molecular sieves adsorb and/or absorb surfactant moisture from the coal fines, where this is facilitated by the agitation of the combination unit 106. In the example of a rotation assembly, the combination unit 106 may include channels through which the combined molecular sieves and coal fines pass, the assembly being rotated at a predetermined speed. The speed and length of the channels controls the time in which the molecular sieves and coal fines are in contact, which directly translates into the corresponding moisture level of the coal fines after separation.

After the agitation of coal fines and molecular sieves in the combination unit 106, the mixture is passed to the separator 108. In one embodiment, a conveyor belt or any other movement means may be used to pass the mixture to the separator 108. In the methodology of FIG. 2, a next step, 124, is separating the molecular sieves from the coal fines. This step is performed using the separator 108 of FIG. 1. From the separator are split out the coal fines 110 and the molecular sieves 112. In this embodiment, the method of dying coal fines takes coal fines from the distribution unit 104, combines them with molecular sieves, wherein moisture is then removed, and then the coal fines are separated from the molecular sieves. The remaining product of this drying method are coal fines 110 having a reduced moisture content level and molecular sieves 112 containing the extract moisture.

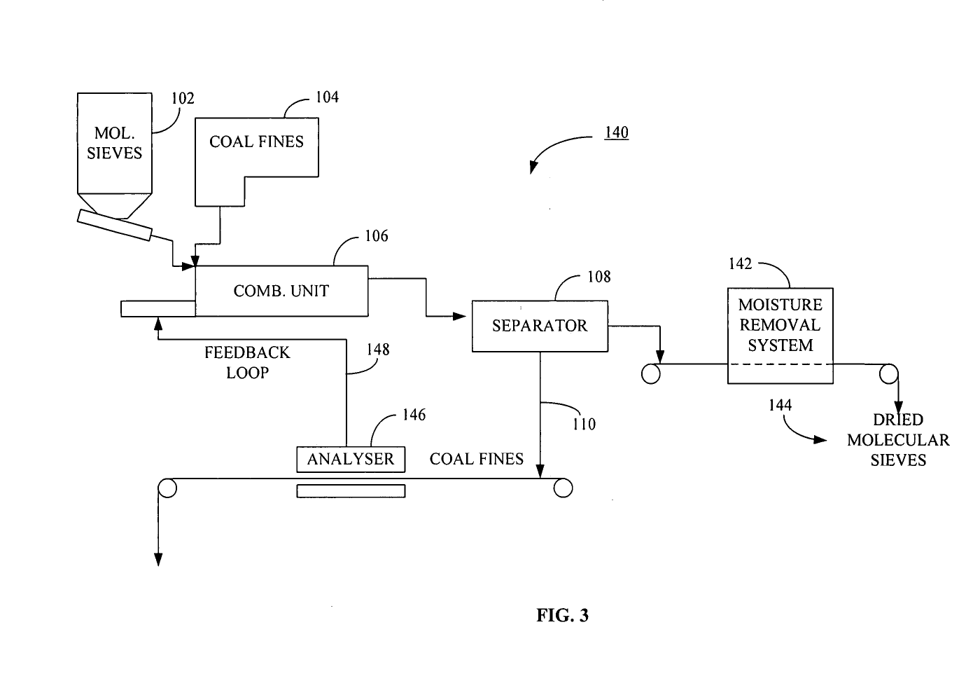

FIG. 3 illustrates another embodiment of a system 140 for drying coal fines. This system 140 of FIG. 3 includes the elements of the system 100 of FIG. 1, the molecular sieve distribution unit 102, the coal fine distribution unit 104, the combination unit 106, the separator 108 and the separated coal fines 110 and molecular sieves 112. The system 140 further includes a moisture removal system 142 and dried molecular sieves 144, as well as a moisture analyzer 146 with a feedback loop 148 to the combination unit 106.

The moisture removal system 142 is a system that operates to remove the moisture from the molecular sieves 112. In one embodiment, the system 142 may be a microwave system that uses microwaves to dry the sieves. The imposition of microwaves heats up the sieves and causes the evaporation of the water molecules therefrom. The microwave signal strength and duration are determined based on calculations for removing the moisture and can be based on the volume of molecular sieves. For example, the large the volume of molecular sieves, the longer the duration of the drying and/or the higher the power of the microwave may be required.

Other embodiments may be utilized for the moisture removal system, wherein other usable systems include operations for removing moisture from the molecular sieves. For example, one embodiment may be a heating unit that uses heat to cause the moisture evaporation. Regardless of the specific implementation, the moisture removal system 142 thereby returns the molecular sieves to a state similar or identical to their state prior to insertion in the combination unit 106 by causing the moisture to be removed and/or eradicated from therefrom, thus generating the dried molecular sieves.

The analyzer 146 is a moisture analyzing device that is operative to determine the moisture level of coal fines passing therethrough. The analyzer 146 may be any suitable type of moisture analysis device recognized by one skilled in the art, such as but not limited to a product by Sabia Inc. that uses a PGNA elemental analysis combined with their proprietary algorithms to measure real time moisture content of a moving stream of coal on a belt using an integrated analyzer feature contained in their SABIA Xl-S Sample Stream Analyzer. SABIA Inc. can also provide their coal blending software CoalFusion to further automate the moisture content measurement process.

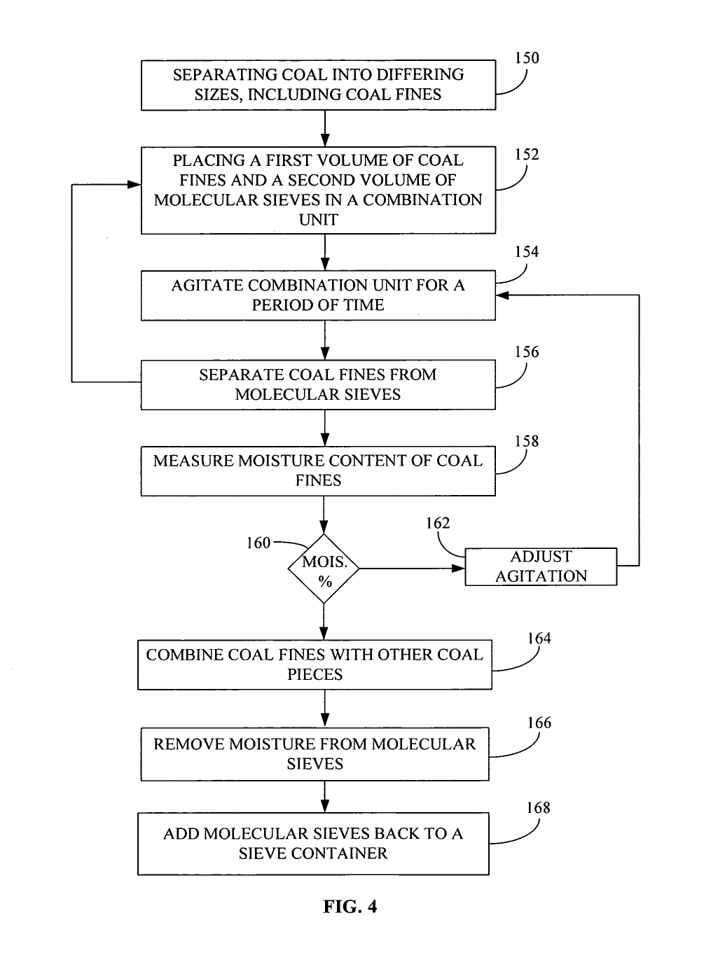

For the sake of brevity, operations of one embodiment of the system 140 are described relative to the flowchart of FIG. 4. FIG. 4 illustrates the steps of one embodiment of drying coal fines and including additional processing operations for a continuous coal fine drying process.

In the methodology of FIG. 4, a first step, step 150 is separating coal into differing sizes including coal fines. This step may be performed using known separation techniques, separating coal fines out from larger pieces. For example, the coal fines may be separated into categories of greater than a quarter inch, quarter inch to 28 mesh and 28 mesh to zero. In this embodiment, the coal fines comprising the coal fines between 28 mesh to zero are provided to the filter cake distribution unit 104. It is recognized that the coal fines are not restricted to a sizing of 28 mesh to zero, but rather can be any other suitable sizing, including being further refined into smaller increments, such as 28 mesh to 100 mm, 100 mm to 200 mm, 200 mm to 325 mm and 325 mm to zero, by way of example.

The next steps of the method of FIG. 5 are, step 152, placing a first volume of coal fines and a second volume of molecular sieves in the combination unit, step 154, agitating the combination unit, and step 156, separating the coal fines from the molecular sieves. These steps may be similar to steps 120, 122 and 124 of FIG. 2.

As illustrated in the system 140 of FIG. 3, the separator 108 separates the molecular sieves from the coal fines such that the separate elements may be further processed separately. Step 158 of the methodology includes measuring the moisture content of the coal fines using the analyzer 146.

Further illustrated in this embodiment, the system 140 is a continuously flow system such that in normal operations, the method of FIG. 4 concurrently reverts to step 152 for the continued placement of coal fines and molecular sieves into the combination unit.

In drying coal fines, it is not necessary to completely remove all moisture, but rather drying seeks to achieve a target range of moisture content. This moisture content then translates into an overall moisture content per weight, e.g. tonnage, of coal. The sale of coal being based on the moisture content, this embodiment allows for refinement of the coal drying process for coal fines based on accurate measuring of the moisture content.

Step 160 is a decision step to determine if the moisture content is above or below a predetermined moisture level. By way of example and not meant to be a limiting value, the combination unit 106 may seek a moisture level at 9.5 percent within a standard deviation range. If the moisture level is above or below that value, step 162 is to adjust the agitation reverting the process back to step 154. Step 162 represents one possible embodiment for adjusting the moisture level, wherein the system 140 is a continuous flow system such that the feedback loop 148 would adjust the combination unit 106 for current coal fine drying operations, not the drying of the coal fines already past the separator 108.

In one embodiment, the combination unit 106 may be a rotational unit including an actuator that controls the rotational speed. Based on the feedback loop 148, this may increase or decrease the speed. For example, if the moisture level is below the desired percentage, this infers that too much moisture is being removed and therefore the amount of contacting engagement between the coal fines and molecular sieves is too long such that the rotational speed is increased. Conversely, if the moisture level is too low, this may indicate the desire to slow down the combination unit 106 to increase the amount of surface engagement time.

Concurrent with the moisture level measurement by the analyzer 146, the method of FIG. 4 includes combining coal fines with other larger coal pieces, step 164. As described above, the coal fines are separated out from other larger coal pieces. These other larger coal pieces can be dried using other available less costly means, such as centrifuges, by way of example. For a variety of reasons, complications exist with applying various drying techniques that work with the larger coal pieces to the coal fines, so the coal fines are separated and dried separately. In step 164, they are recombined for sale.

In the method of FIG. 4, another step, step 166, is the removal of moisture from the molecular sieves. As illustrated in FIG. 3, this may be done using the moisture removal system 142. When the moisture is removed, this generates dried molecular sieves 144, which can then be added back to the sieve distribution unit 102. This allows for re-use of the molecular sieves for continuous drying operations.

With respect to the feedback loop 148, it is recognized that other modifications may be utilized and the feedback is not expressly limited to the combination unit 106. For example, in one embodiment the molecular sieve dispensing unit may include a flow regulator that regulates the volume of molecular sieves released into the combination unit 106. The adjustment of the volume of molecular sieves may be adjusted to change the moisture level of the coal fines, such as if there are more molecular sieves, it may provide for reducing more moisture and vice versa. In another embodiment, the feedback loop may provide for adjustment of the dispensing rate of coal fines from the coal fine distribution device 104.

Regarding the molecular sieves, hydratable polymeric materials or compositions comprising one or more hydratable polymers may be employed to reduce the moisture content of coal fines (e.g., polyacrylate or carboxymethyl cellulose/polyester particles/beads). In one embodiment the hydratable polymeric materials is polyacrylate (e.g., a sodium salt of polyacrylic acid). Polyacrylate polymers are the superabsorbents employed in a variety of commercial products such as in baby's diapers, because of their ability to absorb up to 400% of their weight in water. Polyacrylates can be purchased as a translucent gel or in a snowy white particulate form. Suitable amounts of polyacrylic acid polymers (polyacrylates) sufficient to adsorb the desired amounts of water from coal fines can be mixed with the fines, to quickly dry coal. The polyacrylate, which swells into particles or “balls,” may be separated from the coal fines on suitable size filters or sieves. The particles can either be discarded or recycled by drying using any suitable method (direct heating, heating by exposure to microwave energy, and the like).

The properties of hydrateable polymers, including polyacrylate polymers, may be varied depending on the specifics of the process being employed to dry the coal fines. A skilled artisan will recognize that the properties (gel strength, ability to absorb water, biodegradability etc.) are controlled to a large degree by the type and extent of the cross-linking that is employed in the preparation of hydratablc polymers. A skilled artisan will also recognize that it may be desirable to match the degree of cross-linking with the mechanical vigor of the process being used to dry the coal fines and the number of times, if any, that the particles are intended to be reused in drying batches of coal fines. Typically, the use of more cross-linked polymers, which are typically mechanically more stable/rigid, will permit their use in more mechanically vigorous processes and the potential reuse of the particles.

In another embodiment the hydratable polymer composition employed is a combination of carboxymethylcellulose (CMC) and polyester (e.g., CMC gum available from Texas Terra Ceramic Supply, Mount Vernon, Tex.). Such compositions, or other super adsorbent hydratable polymeric substances, can be used to remove water from coal fines in a manner similar to that described above for molecular sieves or polyacrylate polymer compositions.

By way of example, coal fines (15 g) with a moisture content of 30% by weight are mixed with molecular sieves (15 g, Delta Enterprises, Roselle, Illinois) for about 60 minutes thereby drying the coal fines to <5% moisture by weight. After separating the coal fines from the sieves by sifting, the molecular sieves were weighed and dried in a 100° C. oven. The coal fines were weighed periodically to determine the length of time necessary to drive off the water absorbed from the coal. The process is repeated using the same molecular sieves with a second through sixth batch of coal fines. Coal fines (15 g) with a moisture content of 30% by weight are mixed with a polyacrylate polymer (0.5 g Online Science Mall, Birmingham, Ala.) for about 1 minute thereby drying the coal fines to <5% moisture by weight. After separating the coal fines from the polymer gently sifting the mix, the molecular polyacrylate polymer particles are recovered for reuse after drying.

Thereby, the various embodiments provide methods and systems for drying coal fines. The drying utilizes molecular sieves. Prior uses of molecular sieves were related primarily to gas and liquid applications because of the nature of passing molecules between and across the openings in these sieves and therefore was inapplicable to solids, such as to coal fines. Additionally, prior techniques for drying coal fines focused significantly on legacy technologies due to the infrastructure costs for building these drying systems, along with known environmental hazards which are currently permitable, as well as costs associated with trying new technologies. Therefore in addition to the inapplicability of molecular sieves to solids, the coal processing arts includes an inherent resistance to new technologies for cost and logistical concerns. As described above, the method and system overcome the shortcomings of drying coal fines with the application of molecular sieves in a new technological fashion.

FIGS. 1 through 4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for drying coal fines comprising:
combining a first volume of coal fines with a second volume of molecular sieves;
drying the coal fines through contacting engagement of the coal fines with molecular sieves such that moisture content of the coal fines is reduced by the molecular sieves; and
separating the molecular sieves from the coal fines.

2. The method of claim 1 further comprising:
agitating coal fines and molecular sieves when in contacting engagement.

3. The method of claim 1 further comprising:
drying the coal fines to a first moisture content level.

4. The method of claim 3, wherein the drying of the coal fines to the first moisture content level includes placing the coal fines in contact engagement with the molecular sieves for a first period of time.

5. The method of claim 4 further comprising:
adjusting the first moisture content level by adjusting the first period of time.

6. The method of claim 3; wherein the drying of the coal fines to the first moisture content level includes adjusting the first volume of coal fines for contacting engagement with the molecular sieves.

7. The method of claim 3, wherein the drying of the coal fines to the first moisture content level includes adjusting the second volume of molecular sieves for contacting engagement with the coal fines.

8. A system for drying coal fines comprising:
a combination unit for holding a first volume of coal fines and a second volume of molecular sieves such that a moisture content of the coal fines is reduced by the contacting engagement with the molecular sieves;
a coal fine distribution unit for placing the first volume of coal fines in the combination unit;
a molecular sieve distribution unit for placing the second volume of molecular sieves in the combination unit; and
a separation device for separating the molecular sieves from the coal fines.

9. The system of claim 8 further comprising:
an agitation device for agitating the combination unit and thereby agitating the coal fines and molecular sieves when in contacting engagement.

10. The system of claim 9 further comprising:
a moisture detection device determining the moisture level of the coal fines after being in combination with the molecular sieves.

11. The system of claim 10 further comprising:
a timing device for timing the contact engagement of the molecular sieves and coal fines to achieve a first moisture level of the coal fines based on the engagement of the coal fines and molecular sieves.

12. The system of claim 11 wherein the adjustment of the timing device adjusts the contact engagement time and therein adjusts the moisture content of the coal fines.

13. The system of claim 10 further comprising:
a coal fine volume distribution adjuster for adjusting the first volume of coal fines in the combination unit such that the coal volume distribution adjuster is adjusted based on the moisture detector.

14. The system of claim 10 further comprising:
a molecular sieve volume distribution adjuster for adjusting the second volume of molecular sieves in the combination unit such that the molecular sieve distribution adjuster is adjusted based on the moisture detector.

15. A method for drying coal comprising:
separating a plurality of coal to generate larger coal pieces and coal fines;
placing a first volume of the coal fines in a combination unit;
adding a second a volume of molecular sieves in the combination unit;
agitating the combination unit for a first period of time such that the coal fines are in contacting engagement with molecular sieves, thereby reducing a moisture content of the coal fines;
separating the molecular sieves from the coal fines; and
removing moisture content from the molecular sieves.

16. The method of claim 15 further comprising:
recombining the coal fines with the larger coal pieces.

17. The method of claim 15, wherein the separating of the molecular sieves from the coal fines uses a screening technique.

18. The method of claim 15, wherein the second volume of molecular sieves is drawn from a molecular sieve holding device, the method further comprising:
after removing the moisture from the molecular sieves, placing the molecular sieves in the molecular sieve holding device.

19. The method of claim 15 further comprising:
measuring the moisture content of the coal fines after agitation in the combination unit; and
adjusting the first period of time based on the measured moisture content.

20. The method of claim 15 further comprising:
measuring the moisture content of the coal fines after agitation in the combination unit; and
adjusting at least one of: the first volume of coal fines and the second volume of molecular sieves in the combination unit based on the measured moisture content.
